(19) United States
(12) Patent Application Publication
(10) Pub. No.: US 2011/0271178 A1
(43) Pub. Date: Nov. 3, 2011

(54) CLIPBOARD TRANSFER OF FORMATTED NATIVE TEXTUAL CONTENT FROM ONE COMPUTER SYSTEM TO ANOTHER DIFFERENT COMPUTER SYSTEM

(75) Inventors: Frank P. Feuerbacher, Austin, TX (US); John D. Hannon, Austin, TX (US); Virgil Itliong, Cedar Park, TX (US); Rolf Kocheisen, Austin, TX (US); Brian Nelson, Austin, TX (US); Michael W. Panico, Austin, TX (US); Vijayanand Vinnakota, Austin, TX (US)

(73) Assignee: International Business Machines Corporation, Armonk, NY (US)

(21) Appl. No.: 12/769,940

(22) Filed: Apr. 29, 2010

(51) Int. Cl. G06F 17/21

(52) U.S. Cl. 715/256

(57) ABSTRACT

A user at a first computer system with a defined block of native text/graphics on a clipboard supported by the first computer system is enabled to provide this same block of marshalled native text in its precise format on a clipboard supported by a second computer system that has a different platform or operating system, wherein the marshalled native text on the clipboard of the second system is ready to be unmarshalled and pasted into a text document stored in the second computer transparently, without losing the format or any of the other attributes of the cut native text and graphics, as if it were a simple cut and paste routine on the same computer system.

### TECHNICAL FIELD

The present invention relates to the transfer of a user defined portion of a text document with graphics to another document, particularly by a cut and paste implementation via a clipboard.

### BACKGROUND OF RELATED ART

A clipboard is a conventional implementation wherein cut or copied text, graphics or other components may be temporarily scored before being moved to another location within the same application or another application within the same computer system. A problem arises when the user defined, i.e. cut, contents stored on the clipboard are to be pasted into a destination document in an application on a computer system different from the first computer system having the clipboard on which the cut contents are stored. This is particularly the case where the cut defined portion contains formatted text. It is likely that the transfer to a different computer system will at least lose the formatted structure after paste. Current solutions to this problem have been cumbersome. The user may choose to recreate the whole document and then transfer the whole document containing the defined text. However, even with document being recreated, some formatting may be lost. Transfer schemes involving the transmission of the whole clipboard including the defined portion have been considered. This would present problems in the interpretation of the clipboard format in the different destination computer system. Other solutions require strict coordination between the sending and destination computer systems.

### SUMMARY OF THE PRESENT INVENTION

The present invention provides an implementation for effectively transferring defined portions of native text from a document in a first computer system to an insertion into a destination native text document in a different computer system that circumvents the above-described problems. It should be noted that when a native text document is referred to herein, it is meant to include any graphics included in the text document. The present invention is also applicable to primarily graphics documents with only ancillary text.

In accordance with the present invention, a user is enabled to define a portion in a formatted native text with graphics document stored in a first computer system. This portion is encoded into encoded alphanumeric text, e.g. by using any one of several universally used encoding systems that convert files of binary data into conventional alphanumeric characters; such encoding system includes Uuencode, Base64 and Enc; encoding systems encode the data into ASCII based alphanumeric text files that will be hereinafter described in greater detail. These encoded alphanumeric text files are transmitted to the second computer system via a text transmission process where this alphanumeric text is then decoded into the defined portion of formatted native text that is inserted into a formatted native text document stored in said second computer system.

It should be noted that an important aspect of the present invention involves the marshalling of the data representative of the defined portion of native text/graphics stored in the first computer system into a contiguous block of marshalled data that in turn will be encoded fir the transfer in accordance with the invention.

Because the above-mentioned encoding systems convert files of binary data into conventional alphanumeric characters that are universally used, they are likely to be operable on both the first computer system and the different destination computer system. Accordingly, the present invention is implemented by first storing the defined portion as a block of formatted native text data on a clipboard in the first computer system. This block should be marshalled, i.e. the pieces of data, in the memory of the first computer system that represent the defined block of native text and are stored at diverse or non-collective locations in this memory, are collected into a contiguous block in memory, preferably in a memory buffer. This block is encoded into the encoded alphanumeric text, and then, after transmitting the encoded text, there is a verification that the encoded text is encoded by a format operable on the second or destination computer. Upon such verification, the encoded text is decoded back into the block of marshalled formatted native text, stored on an appropriate buffer in the second computer system. The block is then unmarshalled so that the received block is normally stored in the memory of the second computer system as represented by data at diverse locations in the memory. The transferred, decoded and unmarshalled block of native data may now be selectively inserted from the second or destination computer clipboard into a document stored in the second computer system.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion, illustrating the encoding, transfer and decoding process used in the practice of the present invention;

FIG. 2 is a illustrative diagrammatic view of a computer system that may be used for the first and second computer systems;

FIG. 3 is a general flowchart of a program set up to implement the present invention for encoding, transfer and decoding; and

FIG. 4 is a flowchart of an illustrative run of the program set up in FIG. 3 for encoding, transfer and decoding.

### DETAILED DESCRIPTION OF THE PREFERRED EMBODIMENT

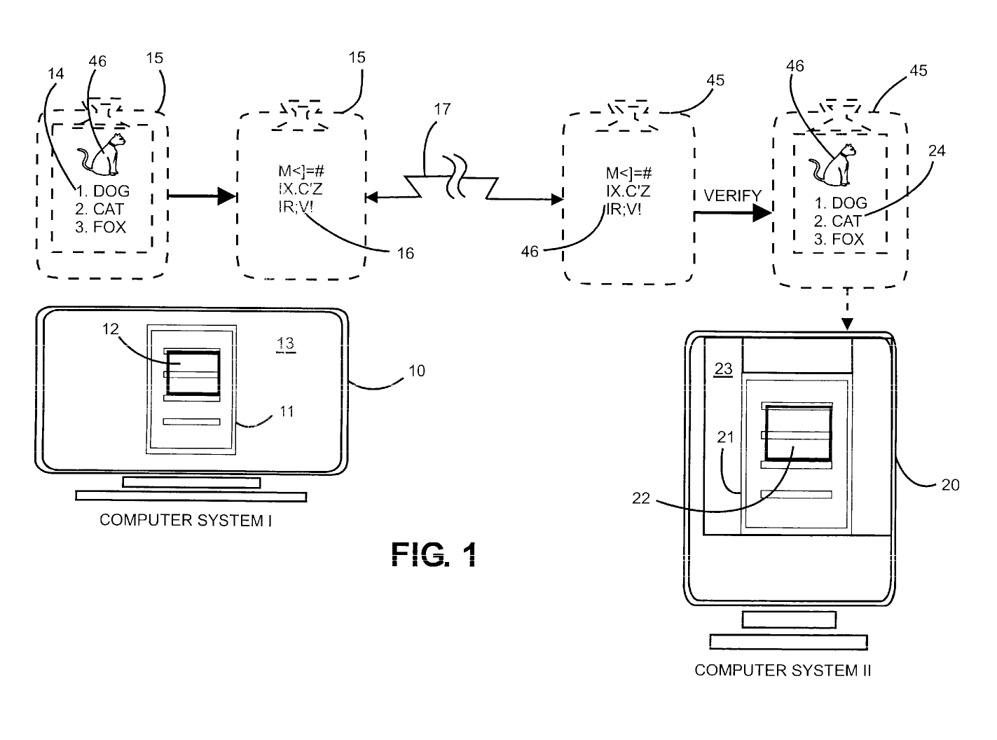

Referring to FIG. 1, there is shown a generalized diagrammatic view of a network portion. In the illustration, a user at Computer System I 10 defines a portion 12 of native text in a native text document 11 displayed on display screen 13. The defined native text is cut as portion 14 on clipboard 15 supported under Computer System I. The native text portion 14 may include graphics such as element 46. The native text on clipboard 15 is then encoded into an encoded portion 16 having an ASCII like text format.

This encoding implementation, for the purpose of illustrating the present invention will have a “Uuencode” structure, may be any of a group of universally used coding structures or schemes including, but not limited to, “Uuencode”, “Base64”, and “yEnc” that convert native language and like text documents into ASCII text. In accordance with the illustration in FIG. 1, any text having the following format:
1. Dog
2. Cat
3. fox
   and graphic element 46 will first be marshalled. In this marshalling, the data representative of this native data and graphics as diversely stored in the memory of computer system I 10 will be formed into a single contiguous block, preferably stored in a buffer. Then, this block, representative of the defined native text portion,
   will be encoded into an ASCII like code that has an appearance: M<]=#IX.C′ZIR;Vn!, stored in a single text buffer, as shown in coded portion 16 on clipboard 15 of the first Computer System I, FIG. 1.

This encoded portion 16 is then transferred 17 to the different Computer System II 20 where, upon receipt, the user would store as coded portion 47 on clipboard 45. Computer System II would then verify that coded portion 47 is a text buffer that has been encoded by a scheme—in the present example Uuencode—that Computer System II has available. Consequently, using Uudecode, the encoded portion 47 will be decoded to marshalled data that was encoded prior to transmission. This marshalled data block is unmarshalled by the Computer System II 10 so that the received block is normally stored in the memory of the Computer System II as represented by data at diverse locations in the memory, wherein the original native text portion 24 on clipboard 45, which is substantially identical to native text portion 14. The text portion 14 is then pasted as portion 22 into text document 21 that may be, for example, a Microsoft Word™ document displayed on screen 23 of the second computer system 20.

It should he noted that the program of the present invention may be implemented as part of the GUI (Graphical User Interface) of Computer System I, the transferring system. If thus implemented, the GUI of Computer System I would automatically provide a menu option to the paste item, wherein the defined portion would be encoded before pasting.

The Uuencode program used in the illustration has been widely used in Unix based systems, i.e. Uuencode: “Unix-to-Unix encoding”. “Uudecode”, of course, reverses the effects of Uuencode to thereby recreate the file of native language text. The Base64 encoding/decoding scheme may also be effectively used in the practice of this invention.

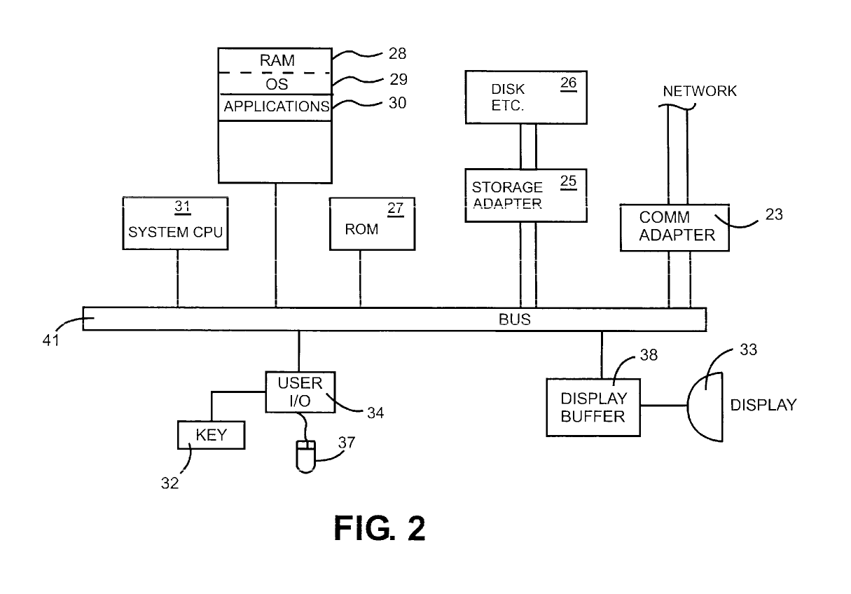

With respect to FIG. 2, there is shown an illustrative diagrammatic view of a computer system that may be used for Computer Systems I and II of FIG. 1. A central processing unit (CPU) 31, such as one of the microprocessors or workstations, e.g. System p™ series, or eServerp5 available from International Business Machines Corporation (IBM), is provided and interconnected to various other components by system bus 21. An operating system OS 29 (e.g. a Linux System) runs on CPU 31, provides control and is used to coordinate the function of the various components of FIG. 2. Operating system 29 may be one of the commercially available operating systems. Application programs 30, controlled by the system, are moved into and out of the main memory Random Access Memory (RAM) 28. These programming applications may be used to implement functions of the present invention. However, it is preferable that the programs used to implement the present invention be in the GUI of the OS 29 connected to CPU 31 via bus 21. ROM 27 includes the Basic Input/Output System (BIOS) that controls the basic computer functions of the hypervisor. RAM 28, storage adapter 25 and communications adapter 23 are also interconnected to system bus 21. Storage adapter 25 communicates with the disk storage device 26. Communications adapter 23 interconnects bus 21 with an outside Web or like network. I/O devices are also corrected to system bus 21 via user interface adapter 34. Keyboard 32 and mouse 37 may be connected to bus 21 through user interface adapter 34. Display buffer 38 supports display 33.

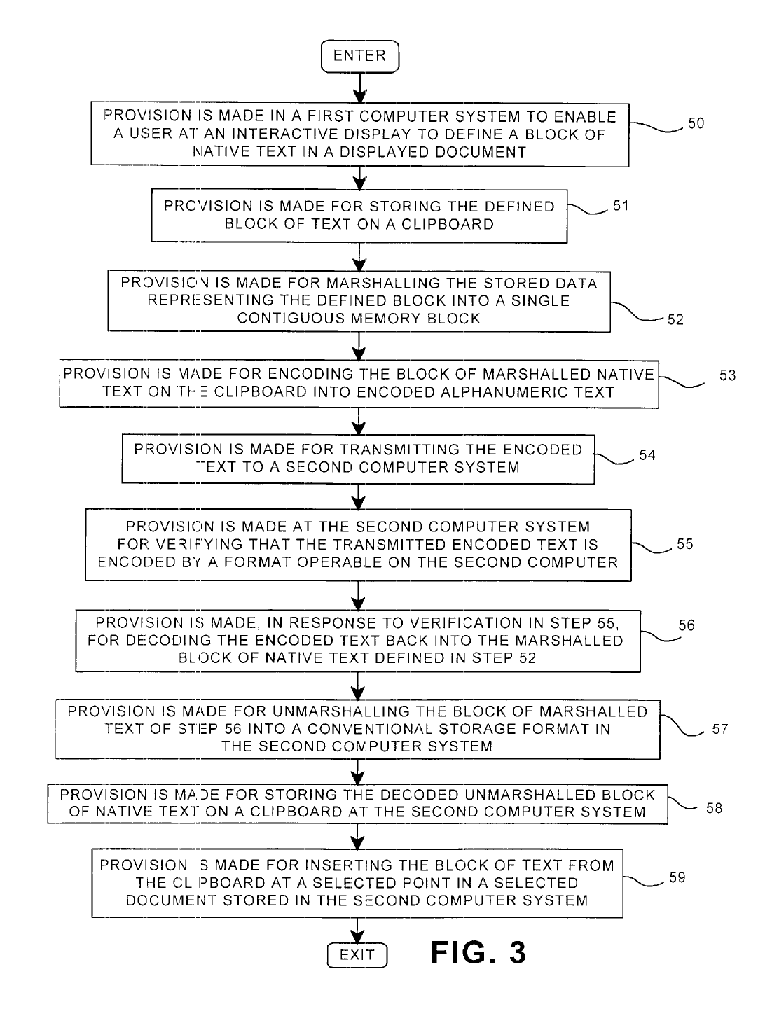

FIG. 3 is a general flowchart of a program set up to implement the present invention through encoding, transfer and decoding. Provision is made in a first computer system to enable a user at an interactive display to define a block of native text in a displayed document, step 50. Provision is made for the storing of the defined block of data on a clipboard in the first computer system, step 51. Provision is made for marshalling the stored data representing the defined block into a single continuous block in memory, step 52. Provision is made for encoding the block of marshalled native text on the clipboard into encoded alphanumeric text, step 53. Provision is made for transmitting the encoded text to a second computer system that is different from the first computer system, step 54. Provision is made at the second computer system for verifying that the transmitted encoded text is encoded by a format operable on the second computer, step 55. Provision is made, step 56, in response to a verification in step 55 for decoding the encoded text back into the marshalled block of native text defined in step 52. Provision is made for unmarshalling the block of marshalled text of step 56 into a conventional storage format in the second computer system, step 57.

Provision is made for storing the decoded and unmarshalled block of native text on a clipboard at the second computer system, step 58. Provision is then mace for inserting the block of text from the clipboard in the second system into a selected point in a selected document stored in the second computer system, step 59.

With the implementation described above, a user at a first computer system with a defined block of native text on a clipboard supported by the first computer system is enabled to provide this same block of native text in its precise format on a clipboard supported by a second computer system that has a different platform or operating system, wherein the native text on the clipboard of the second system is ready to be pasted into a text document stored in the second computer transparently, without losing the format or any of the other attributes of the cut native text, as if it were a simple cut and paste routine on the same computer system.

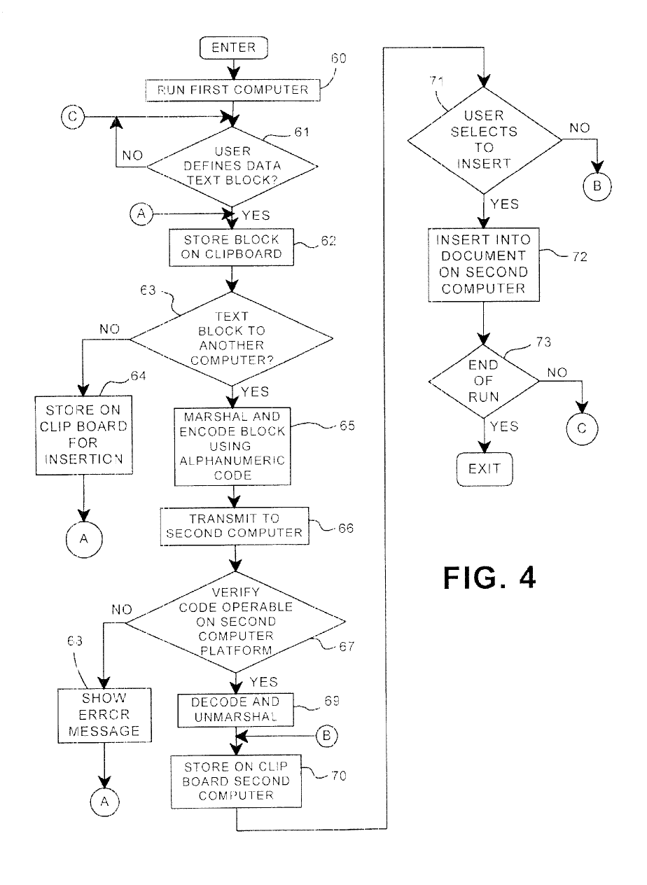

A simple illustrative example of a run of the process set up in FIG. 3 is described with respect to the flowchart of FIG. 4. An application program is being run on a first computer, step 60. As the first computer is being run, a determination is being made as to whether, step 61, the user has defined and cut a block of native text in a document. If Yes, the text is stored on a clipboard, and a further determination is made as to whether the cut native text is to be transferred to another computer system that is different from the first computer system, step 63. If No, the cut text block is conventionally stored in association with the clipboard for subsequent selective insertion in a document in the first computer system, step 64, and the process is branched back to step 62 via “A”. If Yes, the text on the clipboard is to be transferred to another or second computer system, the block of native text is first marshalled as described above and then encoded using an alphanumeric encoding system, such as Uuencode as described above, step 65, and the encoded text is transmitted to this second computer system, step 66. At this point, there is a verification determination made as to whether the alphanumeric code, i.e. Uuencode, in which the text is formatted is supported by the second computer system, step 67. If No, an appropriate error message is shown, step 68, which then may branch back to step 62 via “A”. The first system may try a different encoding implementation such as Base64 or yEncode if such schemes are supported by the first computer system.

However, if the determination at step 67 is Yes, there is a verification, then the encoded text is decoded via Uudecode and unmarshalled, as described above, to its original native text format, step 69, which is stored on a clipboard in the second computer system, step 70. At this point, a determination is made, step 71, as to whether the user has selected to insert the native text stored on the clipboard, if No, the process is branched back to step 70 via “B”, the native text is stored on the clipboard awaiting insertion. If the determination in step 71 is Yes, then the block of cut native text on the clipboard is pasted, i.e. inserted, as selected by the user into an appropriate document in the second computer system, step 72. At this time, a routine determination may be made as to whether the application run is at an end, step 73. If Yes, the application is exited. If No, the process is returned to initial step 61 via branch “C”.

Although certain preferred embodiments have been shown and described, it will be understood that many changes and modifications may be made therein without departing from the scope and intent of the appended claims.

What is claimed is:

1. A method for transferring formatted textual content from one computer system to another comprising:
enabling a user to define a portion in a formatted native text document stored in a first computer system;
encoding said defined portion into encoded alphanumeric text;
transmitting said encoded alphanumeric text to a second computer system via a text transmission process;
decoding said transmitted encoded alphanumeric text into said defined portion of formatted native text; and
inserting said defined portion of formatted native text into a formatted native text document stored in said second computer system.

2. The method of claim 1, wherein said defined portion includes graphics.

3. The method of claim 2, wherein data representative of said defined portion stored in said first computer system is marshalled into a contiguous block of marshalled data.

4. The method of claim 3, wherein said defined portion is encoded into encoded alphanumeric text by a text encoding format operable on the platforms of said first and second computer systems.

5. The method of claim 4, wherein said text encoding process uses the Uuencode format.

6. The method of claim 4, further including:
storing said defined portion as a block of marshalled data on a clipboard;
encoding said block of marshalled data into said encoded alphanumeric text;
after transmitting said encoded text, verifying that said encoded text is encoded by format operable on said second computer;
decoding said encoded text back into said block of marshalled data;
storing said decoded block of marshalled data on a clipboard in said second computer system;
unmarshalling the marshalled data representative of said defined portion; and
selectively inserting said decoded block of native data from said second computer clipboard into said document stored in said second computer system.

7. The method of claim 3, wherein said steps of enabling said user to define said portion, and encoding said defined portion are integrated into the platform of said first computer system.

8. A computer controlled system for transferring textual content from one computer system to another comprising:
a processor; and
a computer memory holding computer program instructions that when executed by the processor performs the method comprising:
enabling a user to define a portion in a formatted native text document stored in a first computer system;
encoding said defined portion into encoded alphanumeric text;
transmitting said encoded alphanumeric text to a second computer system via a text transmission process;
decoding said transmitted encoded alphanumeric text into said defined portion of formatted native text; and
inserting said defined portion of formatted native text into a formatted native text document stored in said second computer system.

9. The system of claim 8, wherein said defined portion includes graphics.

10. The system of claim 9, wherein the performed method includes marshalling data representative of said defined portion stored in said first computer system into a contiguous block of marshalled data.

11. The system of claim 10, wherein said defined portion is encoded into encoded alphanumeric text by a text encoding format operable on the platforms of said first and second computer systems.

12. The system. of claim 11, wherein said text encoding process uses the Uuencode format.

13. The system of claim 11, wherein the performed method further includes:
storing said defined portion as a block of marshalled data on a clipboard;
encoding said block of marshalled data into said encoded alphanumeric text;
after transmitting said encoded text, verifying that said encoded text is encoded by a format operable on said second computer;
decoding said encoded text back into said block of marshalled data;
storing said decoded block of marshalled data on a clipboard in said second computer system;
unmarshalling the marshalled data representative of said defined portion; and
selectively inserting said decoded block of native data from said second computer clipboard into said document stored in said second computer system.

14. A computer usable storage medium having stored thereon a non-transitory computer readable program for transferring textual content from one computer system to another, wherein the computer readable program when executed on a computer causes the computer to:
enable a user to define a portion in a formatted native text document stored in a first computer system;
encode said defined portion into encoded alphanumeric text;
transmit said encoded alphanumeric text to a second computer system via a text transmission process;
decode said transmitted encoded alphanumeric text into said defined portion of formatted native text; and
insert said defined portion of formatted native text into a formatted native text document stored in said second computer system.

15. The computer usable medium of claim 14, wherein said defined portion includes graphics.

16. The computer usable medium of claim 15, wherein the computer program when executed marshalls data representative of said defined portion stored in said first computer system into a contiguous block of marshalled data.

17. The computer usable medium of claim 16, wherein said defined portion is encoded into encoded alphanumeric text by a text encoding format operable on the platforms of said first and second computer systems.

18. The computer usable medium of claim 17, wherein said text encoding process uses the Uuencode format.

19. The computer usable medium of claim 17, wherein the computer program when executed further causes the computer to:
store said defined portion as a block of marshalled data on a clipboard;
encode said block of marshalled data into said encoded alphanumeric text;
after transmitting said encoded text, verify that said encoded text is encoded by a format operable on said second computer;
decode said encoded text back into said block of marshalled data;
store said decoded block of marshalled data on a clipboard in said second computer system;
unmarshall the marshalled data representative of said defined portion; and
selectively insert said decoded block of native data from said second computer clipboard into said document stored in said second computer system.

20. The computer usable medium of claim 16, wherein said program routines of enabling said user to define said portion, and encoding said defined portion are integrated into the platform of said first computer system.
